(19) United States
(12) Patent Application Publication
(10) Pub. No.: US 2010/0005065 A1
(43) Pub. Date: Jan. 7, 2010

(54) ICON PROCESSING APPARATUS AND ICON PROCESSING METHOD

(75) Inventor: Jung-Chi Lai, Guishan Shiang (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Darfon Electronics Corp., Taoyuan (TW)

(21) Appl. No.: 12/495,126

(22) Filed: Jun. 30, 2009

(30) Foreign Application Priority Data
Jul. 4, 2008 (TW) 097125258

(51) Int. Cl. G06F 7/06; G06F 17/30; G06F 15/16

(52) U.S. Cl. 707/3; 707/200; 709/206; 707/E17.014; 707/E17.044

(57) ABSTRACT

The invention discloses an icon processing apparatus, which includes an icon database, a user interface, and a processing module. The icon database stores a plurality of default icons and a plurality of vocabularies corresponding to the default icons. The user interface is connected to the icon database and used for displaying the default icons. A user can input a message which includes at least one target icon among the default icons through the user interface. The processing module is connected to the icon database and the user interface and selects at least one target vocabulary corresponding to the target icon from the plurality of vocabularies. The processing module generates a target sentence based on the at least one target vocabulary.

### BACKGROUND OF THE INVENTION

1. Field of the Invention

The present invention relates to an interactive electronic apparatus, and more particularly, the invention relates to an icon processing apparatus capable of cooperating with internet communication software and having an iconic dictionary.

2. Description of the Prior Art

With the development of interactive technology and internet, people communicate with or maintain relations with each other by use of computers and the internet more and more frequently. The rapidly growing of the internet promotes the improvement of services and application of the internet and also changes the form of communication. Bulletin board system (BBS), internet relay chat (IRC), e-mail and recently-developed instant messenger (IM) show that methods of communicating through computers and the internet are various and more and more abundant in the contents, the operation interface, and the functions thereof.

Instant messenger is the most popular of the present internet communication methods. Communicating with other people through the internet is different from communicating with other people face to face. Users not only interact by words but also exchange emotion symbols, animations, photographs, audio files or video files with others through instant communication software. Because instant messenger has more and more functions, it becomes more and more popular.

The user interface of instant messenger provides the user with kinds of icons (for example, figure icons, emotion icons, weather icons, time icons, and so on) as options for inputting a message. The user could select one or more default icons on the user interface (or together with words) and combine them to be a message. Although the message could be combined with icons, the user still has to input some sentences or words for expressing completely and exactly. However, it is trouble and painful to input for people who are lazy for typing or are bad at typing.

### SUMMARY OF THE INVENTION

In order to solve the mentioned problems, the invention provides an icon processing apparatus capable of combining with instant communication software. The icon processing apparatus has a function of converting icons into phrases or sentences for the avoidance of typing by users. Additionally, the icon processing apparatus of the invention could also analyze words or vocabularies and then combine them to be possible sentences for the users to select. In other words, the user could select icons and combine the selected icons to be a message. Then the message is converted into a target sentence through the icon processing apparatus of the invention.

According to one embodiment of the invention, an icon processing apparatus includes an icon database, a user interface, and a processing module. The icon database stores a plurality of default icons and a plurality of vocabularies corresponding to the default icons. The user interface is electrically connected to the icon database for displaying the default icons. A user can input a message which includes at least one target icon among the default icons through the user interface. The processing module is electrically connected to the icon database and the user interface for selecting at least one target vocabulary corresponding to the at least one target icon from the plurality of vocabularies. The processing module generates a target sentence according to the at least one target vocabulary.

According to another embodiment of the invention, an icon processing method includes steps as followed: (a) displaying the default icons; (b) receiving a message which is inputted by a user and includes at least one target icon among the default icons; and (c) selecting at least one target vocabulary corresponding to the at least one target icon from the plurality of vocabularies and generating a target sentence according to the at least one target vocabulary.

Except instant communication software, the icon processing apparatus of the invention could combine with an electronic dictionary for providing functions of knowledge answers and learning. When the icon processing apparatus of the invention combines with an electronic dictionary, the apparatus could further include a knowledge database and a search module. The knowledge database stores a plurality of knowledge contents. After the processing module generates the above-mentioned target sentence, the search module searches at least one target knowledge content corresponding to the target sentence from the plurality of knowledge contents.

The icon processing apparatus and the icon processing method have advantages as followed: (1) inputting a long message in a shorter time; (2) providing a user with another way to input a message; and (3) increasing convenience and interest in instant communication.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1(A) illustrates an icon processing apparatus according to an embodiment of the invention.

FIG. 1(B) illustrates the icon processing apparatus shown in FIG. 1(A) further including a communication module.

FIG. 1(C) illustrates an electronic dictionary apparatus according to another embodiment of the invention.

FIG. 1(D) illustrates the electronic dictionary apparatus shown in FIG. 1(C) further including an updating module.

FIG. 2 illustrates a flow chart of an icon processing method according to an embodiment of the invention.

FIG. 3 illustrates a flow chart relative to an icon processing apparatus with an electronic dictionary according to another embodiment of the invention.

### DETAILED DESCRIPTION OF THE INVENTION

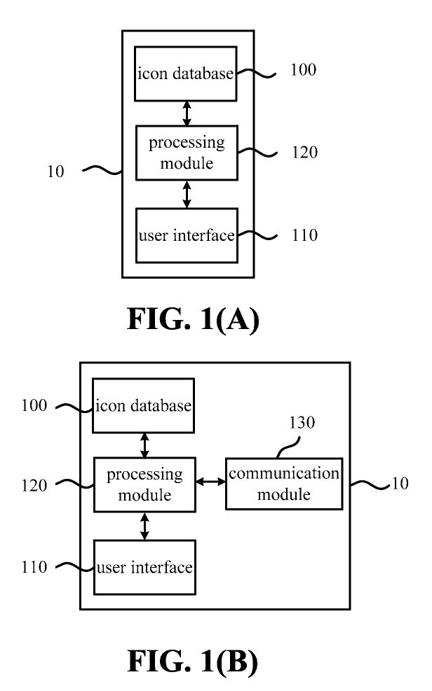

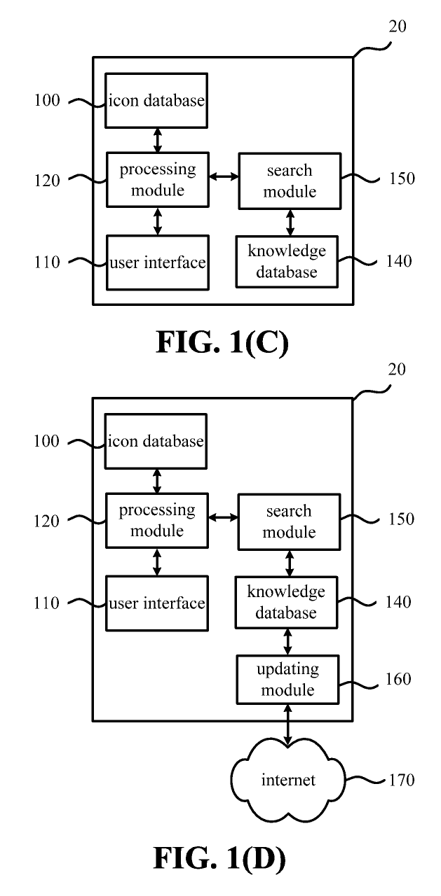

Please refer to FIG. 1(A). FIG. 1(A) illustrates an icon processing apparatus according to an embodiment of the invention. The icon processing apparatus 10 includes an icon database 100, a user interface 110, and a processing module 120.

In this embodiment, the icon database 100 stores default icons relative to figures, emotions, weather, time, temperature, locations, food, sports or punctuation marks. The icon database 100 also stores vocabularies corresponding to each of the icons. According to the invention, a user could modify the default icons and the corresponding vocabularies in the icon database 100 through the user interface 110.

Each of the icons in the icon database 100 could correspond to a plurality of the vocabularies. For example, when a certain message includes a query icon, the position of the query icon in the message may alter the vocabulary that the query icon corresponds to. If the query icon presents at the beginning of a sentence, the query icon may correspond to “when” or “why”? If the query icon presents at the end of a sentence, the query icon may correspond to “what” or “how”? As mentioned above, the user could revise the vocabularies in the icon database 100 through the user interface 110. Thus, the user could alter/increase vocabularies corresponding to the query icon by request or interest.

All or parts of the icons in the icon database 100 are displayed on the user interface 110. When the user would like to input a message and the user would not like to input the message word by word, he could select one or more target icons on the user interface 110 and arrange the target icons to form the message. Alternatively, the user could combine some icons and words to form the message. In practical application, the user interface 110 could be an instant communication software interface. For example, the icon processing apparatus 10 could cooperate with instant communication software, for example, ICQ, QQ, MSN or SKYPE.

According to the invention, after the user inputs the message including the default target icons, the processing module 120 that is electrically connected to the icon database 100 and the user interface 110 will analyze the message. At first, the processing module 120 selects a plurality of target vocabularies corresponding to the target icon from the plurality of vocabularies stored in the icon database 100 and then determines the most proper target vocabulary according to icons/words in front and rear of the target icon.

If the processing module 12 determines that there are kinds of vocabularies that could present the target icon, the processing module 120 could generate a plurality of candidate sentences for choice. For example, when a message inputted by the user includes a food icon and a query icon, the message may be combined by the processing module 120 to generate the following sentences: (1) “What kind of food did you have?” (2) “When did you have a meal?” (3) “Have you had a meal?” The three candidate sentences could be displayed on the user interface 110 for the user to choose. Afterwards, the user could select the most proper target sentence from the candidate sentences (1) to (3).

As shown in FIG. 1(B), the icon processing apparatus 10 shown in FIG. 1(A) could further include a communication module 130. After the user selects the target sentence from the candidate sentences, the target sentence could be sent through the communication module 130 to a receiver at another end of an internet.

Except the instant communication software, the icon processing apparatus of the invention could combine with an electronic dictionary to respond to a question shown in the message by the user and provide functions of knowledge answers and learning. FIG. 1(C) illustrates an electronic dictionary apparatus according to another embodiment of the invention. As shown in FIG. 1(C), except the icon database 100, the user interface 110 and the processing module 120, the electronic dictionary apparatus 20 further includes a knowledge database 140 and a search module 150.

The knowledge database 140 stores a plurality of knowledge contents. In practical application, the target knowledge contents could be words, photographs or films. The search module 150 is connected to the knowledge database 140 and the processing module 120. After the processing module 120 generates a target sentence, the search module 150 receives the target sentence from the processing module 120 and searches at least one target knowledge content corresponding to the target sentence from the knowledge database 140. Then the search module 150 displays the target knowledge content through the user interface 110.

As shown in FIG. 1(D), the electronic dictionary apparatus 20 could further include an updating module 160. The updating module 160 is electrically connected to the knowledge database 140 and an internet 170. When the search module 150 could not search a target knowledge content for the target sentence, the updating module 160 could search on the internet 170 to download a new knowledge content and then store the new knowledge content in the knowledge database 140.

As mentioned above, the electronic dictionary apparatus 20 of the invention has a function of responding to a user's message for responding to a question inputted by the user. The knowledge contents are not limited to words and they could be formed in a various format of photographs, video files or website addresses.

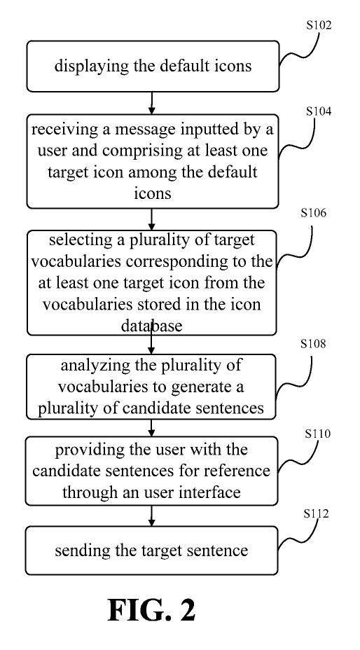

Please refer to FIG. 2. FIG. 2 illustrates a flow chart of an icon processing method according to an embodiment of the invention. The icon processing method is used to cooperate with an icon database that stores a plurality of default icons and a plurality of vocabularies corresponding to the default icons.

At first, the step S102 is executed to display the default icons. For example, the default icons could be displayed on a user interface of an electronic apparatus. Then, the step S104 is executed to receive a message that is inputted by a user and includes at least target icon among the default icons. Afterwards, the step S106 is executed to select at least one target icon corresponding to the at least one target icon from the plurality of vocabularies stored in the icon database.

Subsequently, the step S108 is executed to analyze the plurality of target vocabularies and generate a plurality of candidate sentences. Next, the step S110 is executed to provide the user with the candidate sentences through a user interface for reference and choice. In practical application, the user could select a proper target sentence from the candidate sentences. Finally, the step S112 is executed to send the target sentence.

For example, if the received message in the step S104 includes a dinosaur icon and a query icon and the vocabulary that the dinosaur icon corresponds to is “dinosaur” in the icon database 100, the vocabularies that the query icon corresponds to are “what”, “why”, and “how”. The generated candidate sentences in the step S108 may include: (1) “What kind of dinosaur is this?” (2) “Why is the dinosaur?” (3) “How is the dinosaur?” These candidate sentences could be displayed on the user interface of an electronic apparatus for reference. After the user selects the most proper sentence (for example, the candidate sentence (3)), the selected sentence will be sent out in the step S112.

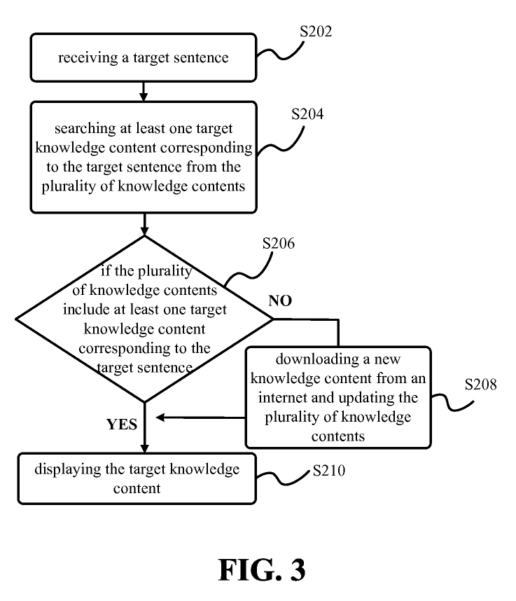

Please refer to FIG. 3. FIG. 3 illustrates a following flow chart under the condition of the icon processing method combined with the electronic dictionary. In this embodiment, after the step S112 is executed, the step S202 is executed to receive the target sentence. Then, the step S204 is executed to search at least one target knowledge content corresponding to the target sentence from the plurality of knowledge contents.

Subsequently, the step S206 is executed to judge if the plurality of knowledge contents include at least one target knowledge content corresponding to the target sentences. If the judgment result in the step S206 is YES, then the step S210 is executed to display the target knowledge content. If the judgment result in the step S206 is NO, the step S208 is executed to download a new knowledge content from an internet and to update the plurality of knowledge contents. After the step S208 is executed, the step S210 is executed to display the knowledge content downloaded from the internet.

For example, if the received target sentence in step S202 is “What was camarasaurus?”, the displayed result in step S210 may be “Camarasurus was a herbivorous dinosaur and the most common of the giant sauropods to be found in North America in size, about 18 meters (60 ft) in length as adults. It lived in the late Jurassic Period (late Oxfordian to Tithonian stages) 150 million years ago”. The displayed result in step S210 may alternatively be presented by audio illustration about the above description or a film relative to a camarasaurus.

In the prior art, the user has to input enough words for generating a more exact and complete sentence. On the contrary, with the icon processing method of the invention, the icons selected by the user could be converted and combined to be a sentence. At this case, the user has not to input the sentence and thus it is more convenient for the user to send an instant message. Additionally, the electronic dictionary apparatus of the invent also provides a more convenient way of inputting that not only responds to the icons selected by the user but also provides the user with a knowledge content relative to a target sentence combined according to the icons.

Compared with the prior art, the invention has advantages of: (1) with the function of converting icons into target sentences, the user being able to send an instant message faster and more conveniently; and (2) providing the user with a relative knowledge content relative to the target sentence for assisting the user in obtaining knowledge information.

Although the present invention has been illustrated and described with reference to the preferred embodiment thereof, it should be understood that it is in no way limited to the details of such embodiment but is capable of numerous modifications within the scope of the appended claims.

What is claimed is:

1. An icon processing apparatus, comprising:
an icon database storing a plurality of default icons and a plurality of vocabularies corresponding to the default icons;
a user interface electrically connected to the icon database for displaying the default icons, a user being able to input a message which comprises at least one target icon among the default icons through the user interface; and
a processing module electrically connected to the icon database and the user interface for selecting at least one target vocabulary corresponding to the at least one target icon from the vocabularies and generating a target sentence according to the at least one target vocabulary.

2. The icon processing apparatus of claim 1, wherein the target icon is relative to a figure, an emotion, weather, time, temperature, a location, food, a sport, or a punctuation mark.

3. The icon processing apparatus of claim 1, wherein the message consists of the at least one target icon and a word.

4. The icon processing apparatus of claim 1, wherein the target icon corresponds to a plurality of target vocabularies, the processing module analyzes the plurality of target vocabularies to generate a plurality of candidate sentences and provides the candidate sentences through the user interface to the user for reference, and the candidate sentences comprises the target sentence.

5. The icon processing apparatus of claim 1, further comprising:
a communication module for sending the target sentence.

6. The icon processing apparatus of claim 1, further comprising:
a knowledge database storing a plurality of knowledge contents; and
a search module electrically connected to the knowledge database and the processing module for receiving the target sentence from the processing module and searching at least one target knowledge content corresponding to the target sentence from the plurality of knowledge contents.

7. The icon processing apparatus of claim 6, further comprising:
an updating module electrically connected to the knowledge database and an internet for downloading a new knowledge content from the internet and storing the new knowledge content in the knowledge database.

8. The icon processing apparatus of claim 6, wherein the target knowledge content is a word, a photograph or a film.

9. The icon processing apparatus of claim 1, wherein the user can revise the default icons and/or the vocabularies in the icon database through the user interface.

10. The icon processing apparatus of claim 1, wherein the user interface is an instant communication software interface.

11. An icon processing method, an icon database storing a plurality of default icons and a plurality of vocabularies corresponding to the default icons, the icon processing method comprising following steps:
displaying the default icons;
receiving a message which is inputted by a user, the message comprising at least one target icon among the default icons; and
selecting at least one target vocabulary corresponding to the at least one target icon from the plurality of vocabularies and generating a target sentence according to the at least one target vocabulary.

12. The icon processing method of claim 11, wherein the target icon is relative to a figure, an emotion, weather, time, temperature, a location, food, a sport or a punctuation mark.

13. The icon processing method of claim 11, wherein the message consists of the at least one target icon and a word.

14. The icon processing method of claim 11, wherein the target icon corresponds to a plurality of target vocabularies and the icon processing method comprises a step as followed:
analyzing the plurality of target vocabularies to generate a plurality of candidate sentences and providing the user with the candidate sentences which comprises the target sentence for reference.

15. The icon processing method of claim 11, further comprising a step as followed:
sending the target sentence.

16. The icon processing method of claim 11, further comprising a step as followed:
searching at least one target knowledge content corresponding to the target sentence from a plurality of knowledge contents.

17. The icon processing method of claim 16, further comprising a step as followed:
downloading a new knowledge content from an internet for updating the plurality of knowledge contents.

18. The icon processing method of claim 16, wherein the target knowledge content is a word, a photograph or a film.

19. The icon processing method of claim 11, wherein the user can modify the default icons and/or the vocabularies in the icon database.

20. The icon processing method of claim 11, wherein the user inputs the message through an instant communication interface.
